(19) United States
(12) Patent Application Publication
(10) Pub. No.: US 2026/0252449 A1
(43) Pub. Date: Aug. 27, 2026

(54) SELECTIVE RESTART OF FUNCTIONALITIES FOR AUTONOMOUS OR SEMI-AUTONOMOUS SYSTEMS AND APPLICATIONS

(71) Applicant: NVIDIA Corporation, Santa Clara, CA (US)

(72) Inventor: Vito MAGNANIMO, Munchen (DE)

(21) Appl. No.: 19/064,437

(22) Filed: Feb. 26, 2025

(51) Int. Cl. G06F 11/14; G06F 9/4401

(52) U.S. Cl. CPC G06F 11/1438; G06F 9/4401; G06F 2201/805

(57) ABSTRACT

The present disclosure relates to systems and methods for controlling restarts of functionalities. The systems and methods may be configured to increase availability of functionalities associated with a system through controlling restarts of functionalities. In some embodiments, a restart of a first functionality may be identified, in which the first functionality is a first type of functionality. An impact of the restart on a second functionality may be determined, in which the second functionality is a second type of functionality. In some embodiments, the restart of the functionality may be controlled based at least on the impact of the restart, the first type of functionality, and the second type of functionality.

### BACKGROUND

Machines, such as autonomous or semi-autonomous machines and robots, include various systems and/or components configured for various functionalities. Such systems and functionalities – when combined – allow the machines to perform operations. For example, a machine may include a powertrain system (e.g., engine, transmission, drivetrain, etc.), a brake system (e.g., anti-lock braking system (ABS), electronic stability control, etc.), a steering system (e.g., power steering, rack and pinion, etc.), a suspension system (e.g., shock absorbers and struts, front and rear suspension, etc.), a fuel system (e.g., fuel tank, fuel pump, fuel injectors, etc.), an electrical system (e.g., battery, alternator, wiring and connectors, etc.), a cooling system (e.g., radiator, thermostat, coolant, etc.), safety systems (e.g., airbags, seatbelts, advanced-driver-assistance systems (ADAS), etc.), a climate control system (e.g., heating, ventilation, and air-conditioning (HVAC), etc.), among others that may operate together to facilitate operation of the vehicle, machine, or robot.

The functionalities may operate in a substantially parallel manner, in which multiple operations are running together. In some instances, various functionalities of a system may have shared resources within the system. For example, different components and/or functionalities may share the memory for the system.

In some instances, a particular functionality may require a restart. For example, a particular functionality may require a restart for software updates, performance degradation, error recovery, among others. Restarting a functionality may affect other functionalities having shared resources with the functionality being restarted. For example, restarting may require using additional portions of the shared resources, which may interfere with other functionalities with respect to the shared resources. Some approaches of reducing the impact that restarts may have on other functionalities may include simple resource allocation. Resource allocation is a process of assigning portions of a system’s resources to different processes or functionalities. However, mere resource allocation may lead to various issues such as loss of flexibility, resource overcommitments, performance degradation, among others.

### SUMMARY

According to one or more embodiments of the present disclosure, systems and methods may be configured to increase availability of functionalities associated with a system through controlling restarts of functionalities. In particular, the embodiments of the present disclosure may help preserve intended operations of certain functionalities while reducing or avoiding interference of such functionalities during restarting of other functionalities. For example, certain functionalities may be prioritized as compared to other functionalities. In some embodiments, the priorities of the functionalities may be determined based at least on categories assigned to the functionalities. In some embodiments, the functionalities may be categorized based on the how the failures of the functionalities may affect the system and in order to allocate sufficient resources for certain functionalities whose consistent performance is needed.

The priorities and/or categories assigned to the functionalities may be used to allocate corresponding resources to the functionalities and to reduce instances of interference experienced and/or caused by the functionalities. For example, the functionalities may be categorized based at least on a certain standard such as one or more respective safety levels associated with the one or more functionalities. Based at least on the respective categories as assigned to the individual functionalities, different resource allocations and/or priorities may be determined for the individual functionalities with respect to controlling restarts of different functionalities.

### BRIEF DESCRIPTION OF THE DRAWINGS

The present systems and methods for improving availability of functionalities of a system by reducing inter-functionality interference are described in detail below with reference to the attached figures, wherein:

FIG. 1 is a diagram illustrating an example monitoring system related to improving availability of functionalities of a system, in accordance with one or more embodiments of the present disclosure;

FIG. 2 is a diagram illustrating an example resource allocation system, in accordance with one or more embodiments of the present disclosure;

FIG. 3 illustrates a flow diagram for a method of controlling restarts of functionalities, in accordance with one or more embodiments of the present disclosure;

FIG. 4A is an illustration of an example autonomous vehicle, in accordance with one or more embodiments of the present disclosure;

FIG. 4B is an example of camera locations and fields of view for the example autonomous vehicle of FIG. 4A, in accordance with one or more embodiments of the present disclosure;

FIG. 4C is a block diagram of an example system architecture for the example autonomous vehicle of FIG. 4A, in accordance with one or more embodiments of the present disclosure;

FIG. 4D is a system diagram for communication between cloud-based server(s) and the example autonomous vehicle of FIG. 4A, in accordance with one or more embodiments of the present disclosure;

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

One or more embodiments of the present disclosure may relate to controlling restarts of various functionalities of a monitored system. The various functionalities may be categorized based at least on one or more standards. In response to detecting a restart of a particular functionality, the restart may be controlled based at least on the impact of the restart on other functionalities and respective categories assigned to the restarting functionality and other impacted functionalities. In the present disclosure, a general reference to a category or categories may also generally refer to the functionalities corresponding to such categories.

In the present disclosure, reference to a “monitored system” may include any systems or machines that include a set of functionalities and/or subsystems. Some examples of a monitored system include vehicles, autonomous vehicles, semi-autonomous vehicles, watercraft, aircraft, drones, robots (e.g., humanoid, autonomous mobile robot (AMR), forklifts, etc.), automobiles, trucks, buses, bicycles, trains, motorcycles, computing systems, among others. In some embodiments, the functionalities may be implemented using corresponding processors. Additionally or alternatively, the functionalities may be implemented using respective virtual machines (VMs) running on the processors. The functionalities and/or subsystems may require a restart for software updates, performance degradation, error recovery, among others. Such restarts may interfere with one or more other functionalities.

In some embodiments, restarts of functionalities may be controlled (e.g., allowed, paused, stopped, etc.) based at least on the potential interference caused by the restarts. For example, based at least on a likeliness that a restart of a particular functionality will interfere with other functionalities, the restart may be allowed, paused, or stopped. In some embodiments, the operations with respect to restarts may be determined based at least on categories or types of the functionality being restarted and the impacted functionalities. For instance, certain functionalities may be prioritized, based at least on the categorizations. In instances that a restart of a first functionality affects operations and/or availability of a second functionality with higher priority than the first functionality, the restart of the first functionality may be paused or stopped.

Additionally or alternatively, in some embodiments, resources of the monitored system, such as memory, may be pre-allocated to certain functionalities based on the categories assigned to the functionalities. In these and other embodiments, impact on such pre-allocated resources may be monitored during restarts of various functionalities to identify varying degrees of inference. In these and other embodiments, the allocation of resources may refer to dedicating certain portions of resources for different functionalities such that the certain portions of resources remain available for associated functionalities.

In some embodiments, the categories of a set of categories assigned to the functionalities may be defined based at least on varying levels of availability requirements. In the present disclosure, “availability” may refer to how a functionality may remain available in a functioning condition and ready for use. In some instances, “availability” may be measured by comparing uptime to total time including uptime and downtime. In the present disclosure, reference to “uptime” may refer to the total time an assessed system or components associated therewith are operational and performing intended functions and reference to “downtime” may refer to the total time the system or components are non-operational due to failures, maintenance, or other issues.

In some embodiments, the varying levels of availability requirements may be defined based at least on one or more respective safety levels associated with the various functionalities. For example, different functionalities may be subject to different levels of safety requirements or standards. For example, in instances in which an assessed system is a vehicle, certain functionalities, such as braking system, may be subject to higher level of safety standards compared to other functionalities such as functionalities related to entertainment (e.g., audio playback). In these and other embodiments, the availability levels may be defined to reflect such safety levels. For example, the level of availability requirement for functionalities such as the braking system may be higher than the level of availability requirement for functionalities related to entertainment, such that safety of the assessed system may be preserved and/or improved.

In some embodiments, the resources of the monitored system may be allocated to the functionalities based on the different categories. For example, in instances in which the categories are defined based on different safety levels associated with the functionalities, more resources may be allocated for functionalities that are highly related to the safety of the system (and categorized accordingly). Contrastingly, little to no resources may be allocated to functionalities that do not directly affect safety of the system.

One or more embodiments of the present disclosure may help improve the operation of monitored systems. For example, one or more embodiments of the present disclosure may be directed to a monitoring system configured to monitor restarting or rebooting of the functionalities and/or components of the monitored systems to reduce the impact that such restarting of the functionalities may have on availability of other functionalities. For instance, in response to detecting an initiation of a restart for a functionality, the monitoring system may determine to allow, pause, or stop the restart based on impact of the restart on availability of functionalities. Additionally or alternatively, specific resources may be allocated to the functionalities based on categories assigned to the functionalities. The categories may help allocate the resources in an efficient manner such that functionalities may satisfy associated availability requirements.

By contrast, some existing approaches of reducing such interferences may include mere memory allocation. For example, to facilitate running of different subsystems (e.g., processors) or VMs on the host system, memory allocation may be implemented. Memory allocation is a process of assigning portions of a system’s memory to different processes or functionalities. For example, for a hypervisor running multiple VMs, the hypervisor may determine how to allocate the memory of the host system’s physical memory. For instance, the host system may include a random-access memory (RAM), in which individual VMs may be allotted a portion of the RAM. Memory allocation may allow sufficient memory is allocated to different VMs.

The hypervisor may allocate the physical memory using different methods. For example, the hypervisor may allocate memory using static allocation or dynamic allocation. Static or fixed memory allocation refers to assigning specific amount of memory to individual VMs or applications at time of initialization of the VMs. Such approaches may guarantee specific amounts of memory to the individual VMs. However, the use of memory may be inefficient as some VMs may not fully use the allocated memory. Such unused memory is still reserved even when the memory is not used, wasting the reserved portion of the memory. Additionally, such an approach limits flexibility of memory as the allocation may not be adjusted. In some instances, the system may overcommit memory. Memory overcommitment refers to instances in which the system allocates more memory total to processes or VMs that is physically available with an assumption that not all processes will use allocated memory at the same time.

Dynamic memory allocation refers to allocating memory to VMs dynamically based on workloads. For example, a memory allocation module may monitor workloads of the VMs and allocate different portions of memory to the VMs. Such approach may help allocate memory more efficiently as less memory may be wasted (allocated without being used). However, such approach may cause performance degradation with frequent adjustment to memory allocation. For example, memory ballooning may degrade performance of other VMs or applications. While discussed with respect to memory, any other types or resources may be allocated.

By contrast, the monitoring system in accordance with one or more embodiments of the present disclosure may allocate resources based on specific categories and/or availability requirements associated with the functionalities instead of mere basic static or dynamic resource allocation. The monitoring system may further monitor the functionalities such that availability requirements are met. Such an approach may help improve availability of functionalities while reducing memory overcommitment or performance degradation.

The systems and methods of the present disclosure may be implemented across a variety of different platforms that may generate any sort of applicable output and/or that may use annotations for improvement thereof. For example, the systems and methods may be used to improve software development in various environments, such as cybersecurity environments (e.g., NVIDIA^{®}’s LaunchPad), simulation environments (e.g., NVIDIA^{®}’s Drive SIM^{®}), software development kits (e.g., NVIDIA^{®}’s DriveWorks, NVIDIA^{®}’s Omniverse), software application toolkits (e.g., NVIDIA^{®}’s CUDA^{®} Toolkit), or any other suitable platform for which software may be developed and improved by improving annotations related to outputs produced by the software.

The systems and methods described herein may also be used for a variety of other purposes and implemented in a variety of other systems, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in and/or be used to improve a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA’s OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models – such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

Further, one or more embodiments of the present disclosure may relate to assessing behavior or outputs associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. In the present disclosure, reference to an “autonomous machine” or “semi-autonomous machine” may include any machine (e.g., vehicle) that may be configured to perform one or more autonomous or semi-autonomous navigation or movement operations. As such, such machines may also include machines in which an operator is required or in which an operator may perform such operations as well.

In some instances and implementations, one or more ML models may be used and/or improved upon (e.g., trained) based on annotations of their corresponding outputs such that the assessment of the annotations and/or corresponding annotators may be used to improve the models themselves. In some embodiments, the ML models may be packaged as a microservice – such an inference microservice (e.g., NVIDIA NIMs) – which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples – such as where the model is large – the model may be hosted/stored in the cloud (e.g., in a data center) and/or may be hosted on-premises and/or at the edge (e.g., on a local server or computing device, but outside of the container). In such embodiments, the model may be accessible via one or more APIs - such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA’s Triton Inference Server, and/or one or more APIs for high performance deep learning inference, which may include an inference runtime and model optimizations that deliver low latency and high throughput for production applications – such as NVIDIA’s TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be performed within a simulation environment (e.g., NVIDIA’s DriveSIM, NVIDIA’s ISAAC GYM, NVIDIA’s ISAAC SIM, etc.) using simulated data (e.g., simulated sensor data of simulated sensors of a virtual or simulated machine, simulated system data, etc.). For example, the system(s) described herein may be deployed as hardware-in-the-loop during simulation to test the performance of the availability functionalities described herein. For example, simulated sensor or other data may be used to perform availability and safety analysis, and this information may be used during operation of the virtual machine within the environment. These simulated operations may be used to test performance of the underlying algorithms, systems, and/or processes prior to deploying them in the real-world. In some instances, the simulation may be used to generate synthetic training data. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to perform availability and/or safety analysis, for example. In any example, such as where a simulation environment is used for testing, validation, training, etc., the simulation environment and/or associated training data may be rendered or otherwise generated using one or more light transport algorithms – such as ray-tracing and/or path-tracing algorithms. In some embodiments, the simulation environment and/or one or more objects, features, or components thereof may be generated or managed within a three-dimensional (3D) content collaboration platform (e.g., NVIDIA’s OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA’s PhysX SDK, in order to simulate real physics and physical interactions with simulations hosted by the platform. The platform may integrate OpenUSD along with ray tracing/path tracing/light transport simulation (e.g., NVIDIA’s RTX rendering technologies) into software tools and simulation workflows for building, training, deploying, or testing AI systems – such as systems for testing, validating, training (e.g., machine learning models, neural networks, etc.), and/or other tasks related to automotive, robot, machine, or other applications.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot’s surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

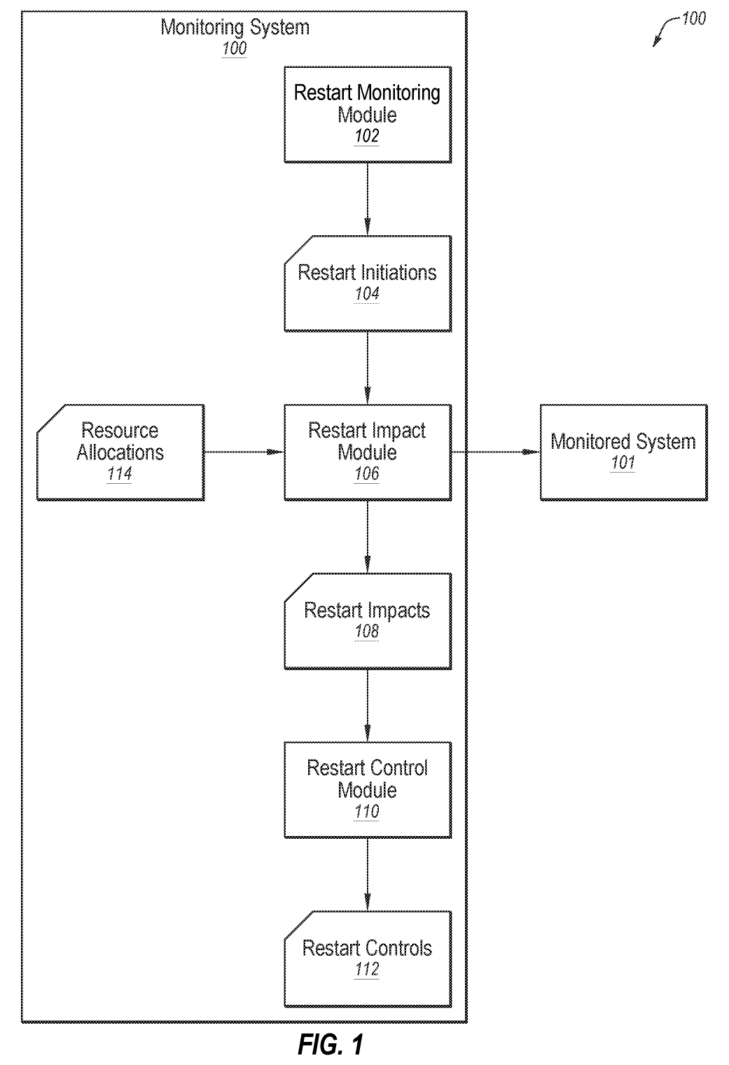

With respect to FIG. 1, FIG. 1 illustrates an example monitoring system 100 configured to control functionality restarts, arranged in accordance with one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In general, the monitoring system 100 may relate to monitoring functionalities of a system (e.g., monitored system 101). The monitored system 101 may include a set of functionalities associated with the monitored system. In some embodiments, the functionalities may be implemented using computing entities or subsystems of the monitored system. For example, the subsystems may include different processors configured to implement corresponding functionalities. Additionally or alternatively, the subsystems may include virtual machines (VMs) running on the processors. The VMs may be configured to implement the respective functionalities. In some embodiments, multiple VMs may be configured to run on a single subsystem.

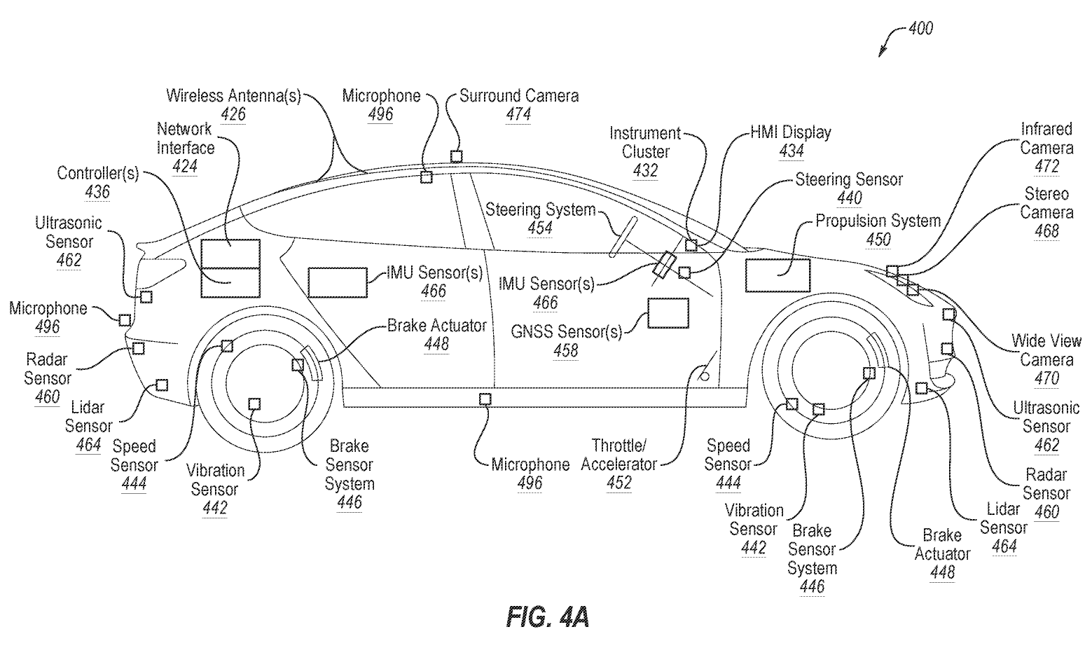

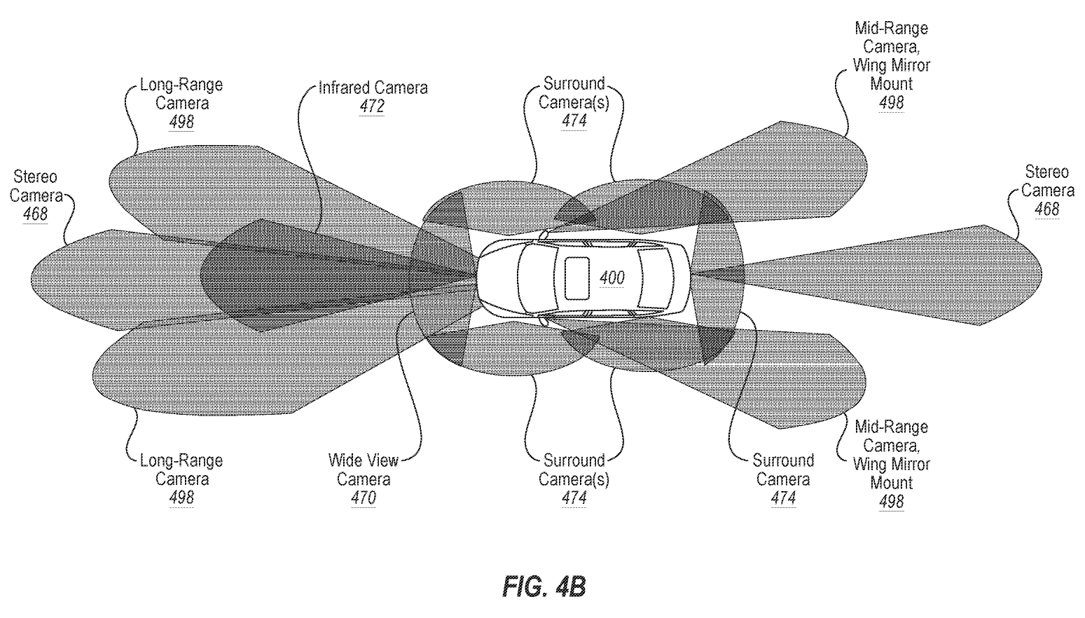

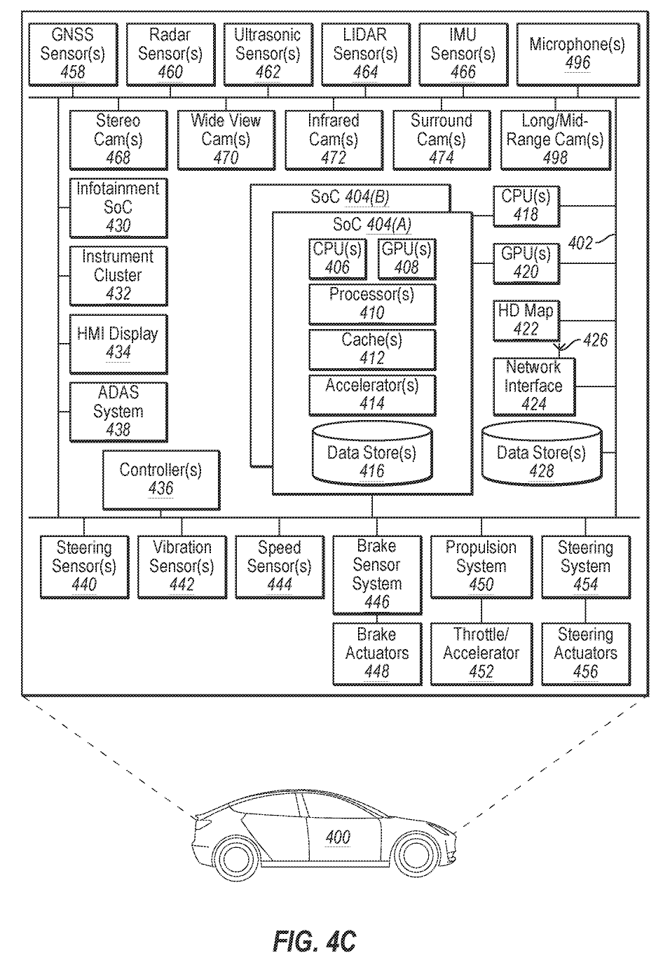

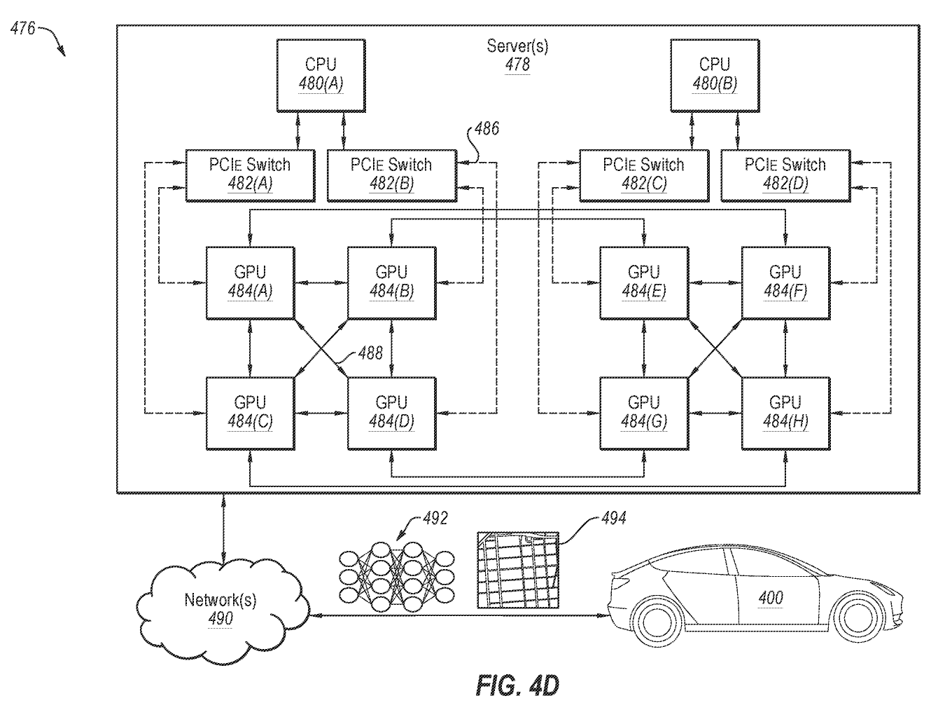

In these and other embodiments, the monitored system may include various types of components and/or machines that include subsystems configured for various functionalities. For example, the monitored system may be a vehicle or an autonomous vehicle such as the vehicle 400 of FIGS. 4A-4D. The vehicle may include multiple subsystems configured for different functionalities for the vehicle.

In some embodiments, the monitoring system 100 may be a part of the monitored system 101. For example, the monitoring system 100 may be a subsystem of the monitored system 101. Additionally or alternatively, the monitoring system 100 may be an external system configured to monitor the monitored system 101.

In some embodiments, the functionalities and/or the corresponding subsystems of the monitored system 101 may require a restart. In the present disclosure, a reference to a functionality may include a reference to a subsystem associated with the functionality. In some embodiments, the functionalities may require restarts due to various reasons. For example, the functionalities may require restarts for system updates (e.g., operating system updates, software updates, among others), memory leaks, configuration changes, resource conflicts or exhaustion, software crashes, network issues, security concerns (e.g., malware or unauthorized changes, access control changes, among others), dependency issues, error recovery, hardware failure, system stability, performance degradation, among others.

In some embodiments, a restart of a particular functionality may have an impact on or interfere with other functionalities of the monitored system 101. For example, the restart may affect resources used to implement the other functionalities. In these and other embodiments, the monitoring system 100 may be configured to monitor and control the restarts of the functionalities such that the impact of the restarts may be controlled. In some embodiments, the monitoring system 100 may include a restart monitoring module 102 (also referred to as a monitoring module 102) configured to monitor the functionalities. For example, the monitoring module 102 may be configured to monitor the functionalities in real time to detect restart initiations 104 or functionalities initiating restarts.

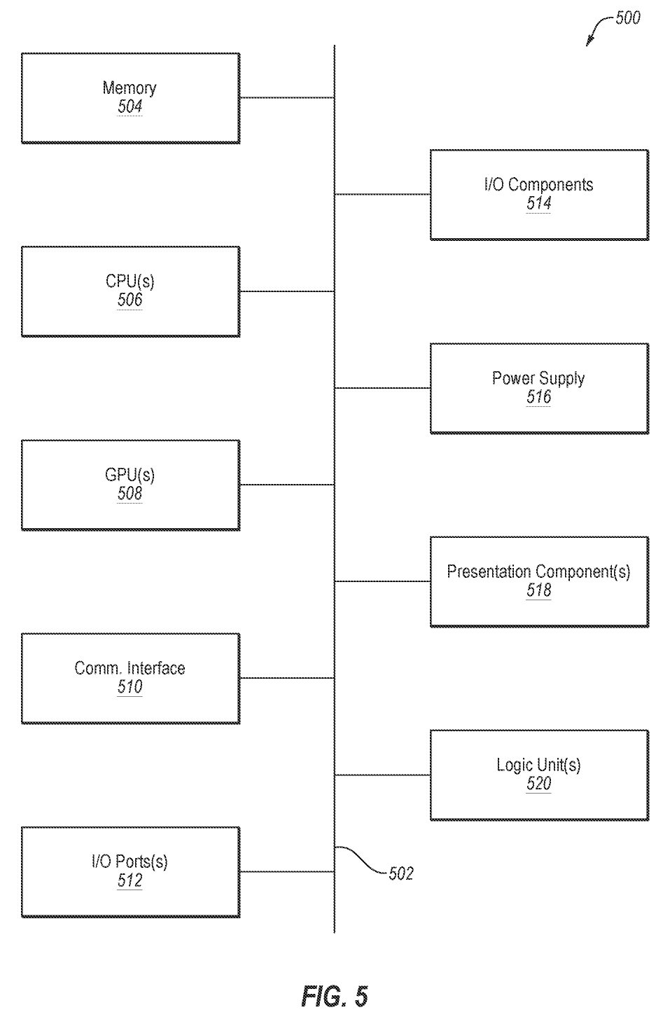

In some embodiments, one or more of the modules and/or processes described herein may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as the computing device that described in further detail with respect to FIG. 5.

In some embodiments, the restart initiations 104 may include different operations performed by the functionalities over a restart process. For example, in general, the restart process may include trigger detection, graceful shutdown or preparation, resource release and cleanup, reset state, restart the functionality, health checks and validation, and completion. The trigger detection may include detecting a specific condition requiring a restart. Such conditions may include internal process detection (e.g., issues within the functionality that require a restart) or external signals such as system updated or configuration change. The graceful shutdown may refer to the process of shutting down a system, service, or application in a controlled and orderly manner, ensuring that the functionality terminates without causing data loss, corruption, or disruptions. In these and other embodiments, the restart initiations 104 may include any of the operations associated with the restart process. Additionally or alternatively, the restart initiations 104 may include the specific functionalities starting or initiating the restart process.

In some embodiments, the monitoring system 100 may include a restart impact module 106 configured to monitor and determine the impacts of the restarts. In some embodiments, the restart impact module 106 may be configured to determine which functionalities may be impacted by the restarts and/or to monitor such functionalities.

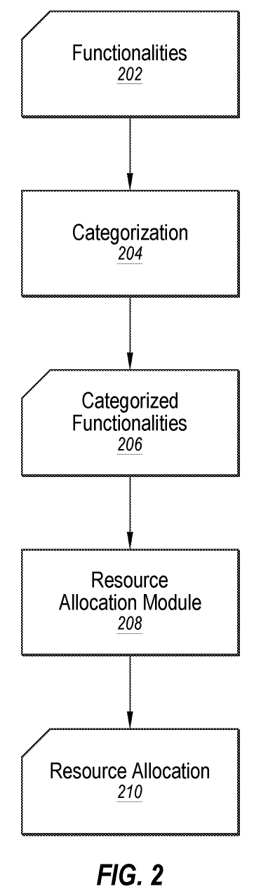

In these and other embodiments, restart impact module 106 may be configured to identify such functionalities based at least on the restart initiations 104. For example, the restart impact module 104 may monitor the functionalities associated with the restart initiations 104. In some embodiments, the restart impact module 104 may be configured to determine the impact of the restarts identified in the restart initiations 104 on other functionalities based at least on resource allocations 114. The resource allocations 114 may represent various resources allocated to different functionalities such that the functionalities may operate efficiently and meet performance goals. In some embodiments, the allocated resources may include computing resources (e.g., CPU resources, such as amount of CPU time assigned to a functionality, and/or GPU resources), memory (e.g., physical memory), disk space (e.g., storage allocated to store data such as application files, logs, etc.), network bandwidth, input/output (I/O) (e.g., resources dedicated to I/O operations, such as reading and writing to disk), threads and processes, among others. The resource allocations 114 may represent allocations for different functionalities. In some embodiments, the resource allocations 114 may vary depending on types of the functionalities. In some embodiments, the resource allocations 114 and the process of determining the resource allocations 114 may be described in further detail with respect to FIG. 2 of the present disclosure.

In some embodiments, the restart impact module 106 may monitor the restarting functionalities and determine restart impacts 108 based at least on how the restarts affect resources allocated to other functionalities. For example, as functionalities restart, the restarts may have varying impacts on the resources allocated to other functionalities. For example, the restarts may have an interface on the other functionalities. For example, the restarts may cause resource contention. For instance, during restarts, the monitored system 101 may temporarily lose or shift resources (e.g., CPU, memory) allocated to the restarting functionalities. In instances in which the shifted resources are not reallocated efficiently, other functionalities may experience increased contention for the remaining resources.

Additionally or alternatively, the restarts may cause temporary unavailability of resources. For example, as a functionality restarts, the functionality may release or lock some resources (e.g., memory, disk, among others) that were previously used. Such a lock on the resources may cause the locked resources to be temporarily unavailable to other functionalities.

Additionally or alternatively, a restart may introduce overhead in resource usage as the monitored system 101 may need to clean up, reset, and/or reinitialize certain components. For example, CPU usage might spike temporarily during the restart as functionalities are shut down and restarted. In some embodiments, a restart may consume resources during startup (e.g., loading increased amount of data into memory or reinitializing databases).

In these and other embodiments, the restart impacts 108 may represent different functionalities affected by restart initiations 104 and the levels of the impacts. In these and other embodiments, the levels of the impacts may represent the extent the allocated resources, as indicated by the resource allocations 114 and/or the operations of the functionalities, are affected or interfered by the restarts. For example, the resource allocations 114 may allocate 128 megabytes (MB) of RAM to an engine control unit (ECU) and associated functionalities (e.g., software that manages engine operations, fuel injection, ignition timing, among other). In some instances, a restart initiation of another functionality, such as an infotainment system, may affect the memory allocated to the ECU. For example, the restart of infotainment system may use certain portion (e.g., 20 MB of the 128 MB) of memory that is allocated to the ECU. In such instances, the resource allocations 114 may indicate that 20 MB of 128 MB allocated to the ECU was affected by the restart initiation 104 of the infotainment system. In some embodiments, the restart impacts 108 may be measured based at least on aliveness of the functionalities. Aliveness may refer to a measure of how often a functionality is invoked or executed. For example, an operating system or a scheduler may be configured to manage the frequency with which functionalities are scheduled for execution. The aliveness may refer to the frequency of operations associated with the functionalities scheduled by the scheduler. For example, a particular functionality may be scheduled to read data every 30 milliseconds (ms), in which the aliveness may may be 30 ms. The particular functionality may be considered alive as it continues to read scheduled data every 30 ms. In some embodiments, as the frequency deviates from the scheduled frequency, the deviation may be monitored with respect to warning threshold. The warning thresholds may vary for different functionalities and may indicate a level of aliveness at which the operations of the functionalities may affect operation and/or safety of the system. For example, the particular functionality may have a warning threshold of 5 ms, in which instance, as the interval between the functionality reading data reaches 35 ms, the warning threshold may be met, and the particular functionality may be found affected by a restart.

As an example, an emergency braking system may be scheduled to periodically check sensor data to respond to different scenarios in real time. For example, the emergency braking system may be scheduled to read the sensor data every 5 ms. In instances in which the sensor data is read outside of the scheduled periods (e.g., read every 8ms), the delay may indicate that the engine or VM running the emergency braking system may be affected by interference, such as interference caused by another functionality (running on the same hypervisor) restarting. The braking system may have a warning threshold of 5 ms, in which instance, as the sensor data is read every 10 ms or more, the warning threshold may be met, and the emergency braking system may cause safety issues. In such instances, appropriate actions may be determined and/or taken such that the aliveness or the frequency of the functionality may be controlled.

In some embodiments, the monitoring system 100 may include a restart control module 110 configured to control the restarts of the functionalities based at least on the restart impacts 108. In some embodiments, the restart control module 110 may be configured to determine one or more restart controls 112 based at least on the restart impacts 108. In some embodiments, the one or more restart controls 112 may include allowing the restart to proceed, pausing the restart, or stopping the restart, among others. For example, certain restarts may be allowed to proceed, while some other restarts are paused and allowed to resume at certain points or after satisfying certain conditions. Other restarts may be completely stopped.

In some embodiments, the restart control module 110 may determine the one or more restart controls 112 based at least on the priorities of functionalities that are restarting and the priorities of the functionalities affected by the restarts. For example, individual functionalities of the monitored system 101 may be assigned priorities or assigned to a certain level of priority of a set of priorities.

In some embodiments, the priorities may be determined based at least on a certain standard. For example, in some embodiments, the priorities may be determined based at least on a safety standard. For example, the functionalities related to safety of the monitored system 101 may be assigned higher priorities than other functionalities that do not affect safety of the monitored system 101. For example, a functionality associated with a braking system may be assigned higher priority than a functionality associated with infotainment systems.

In some embodiments, the priorities may be determined based on any suitable standard. For example, the priorities may be determined and/or assigned based at least on a known safety standard such as ISO 26262, an international standard for the functional safety of electrical and electronics systems in road vehicles. In these and other embodiments, the functionalities may be categorized based at least on the standard, in which different categories are associated with different priorities.

As an example, with respect to a safety standard, the functionalities of a system may be decomposed into categories of safety-available functionalities, safety-non-available functionalities, and non-safety functionalities.

The safety-available functionalities may include functionalities with specific availability and/or reliability requirements for safety. For instance, such functionalities may have a specific availability requirement, such as being available at all times the system is operating, for the system to be meet the standards. For example, in instances in which the system corresponds to an autonomous vehicle, the safety-available functionalities may include trajectory evaluation. Trajectory evaluation involves assessing potential paths that a vehicle may take to navigate safely and efficiently through the environment. Trajectory evaluation is highly important for safe and effective navigation of the autonomous vehicle, therefore having a specific availability requirement.

In some embodiments, the safety-available functionalities may include functionalities or associated components configured for failover or fallback. Failover may refer to automatic switching to a backup system in response to the primary system failure. Fallback may refer to a backup mechanism or alternative process that a system may utilize in response to the primary function being unavailable. Components configured for fallback operations may have specific or high availability requirement (e.g., need to be available at all times) as failure of fallback functionalities or components may directly affect safety of the system with respect to the safety standards.

Additionally or alternatively, safety-available functionalities may include functionalities needed to avoid degradation of the system. For example, functionalities related to thermal and/or voltage monitoring may be assigned to safety-available functionalities as such monitoring is highly important for maintaining proper performance of certain hardware components without causing system failures.

The safety-non-available functionalities may include functionalities whose operations are important, but whose failures do not directly impact operations of the system with respect to the safety standards. For instance, the safety-non-available functionalities may include functionalities that may go into a safe state in response to a failure without causing issues. For example, such functionalities may be subject to failover in response to a failure such that the system may continue operating in at least some capacity consistent with its safety targets instead of a system failure occurring in response to losing such functionality. For example, safety-non-available functionalities may include software updates, functionalities executing during the initialization phase, and/or a resource manager capable of failing without causing a whole failover of the system, among others. Such functionalities are still considered as possible sources of failures, but failures of such functionalities are allowed, as even with the failures, the operations associated with such functionalities may still be performed (e.g., by other functionalities or components).

Non-safety functionalities or other functionalities may include functionalities that do not have availability requirements or whose failures won’t affect the system with respect to the safety standard. For example, a component or a tool related to graphics drivers (e.g., replated to displaying and managing graphics settings on various displays) may be a non-safety functionality. Failure of graphics drivers may lead to failure of optimizing graphics performance in providing high-quality visuals. However, failure of such functionality does not lead to a system failure that affects safety of a machine. For instance, a safety standard, such as ISO 26262, may not have a requirement or a standard for such functionalities. As another example, functionalities related to Wi-Fi connectivity and/or Bluetooth connectivity may be non-safety functionalities. Such functionalities provide functions in improving user experience and functions of the machines. However, failures of such functionalities do not lead to system failures or affect safe operations of the system.

In these and other embodiments, the safety-available functionalities may be assigned highest priorities, the safety-non-available functionalities may have lower priorities, and the non-safety functionalities or other functionalities may be assigned the lowest priorities. While described with respect to a particular safety standard, any other suitable safety standards or other types of standards may be used to assign priorities.

Additionally or alternatively, the priorities may be customized by a user. For example, in some embodiments, the user may specifically assign certain priorities to specific functionalities. As another example, the user may provide or lay out certain custom standards to categorize and/or prioritize the functionalities.

In some embodiments, the restart control module 110 may be configured to compare the priorities of the restarting functionality and the affected functionality. For instance, the restart impacts 108 may indicate that a restart of a first functionality is interfering with operations of a second functionality. For example, the aliveness of the second functionality may be getting close to or reaching a warning threshold associated with the second functionality. In such instances, the restart control module 110 may compare the priorities of the first functionality and the second functionality to determine whether to allow, pause, or stop the restart of the first functionality.

For example, in response to determining that the priority of the first functionality is higher than the priority of the second functionality, the restart may be allowed. Contrastingly, in response to determining that the priority of the first functionality is lower than the priority of the second functionality, the restart of the first functionality may be paused or stopped.

Additionally or alternatively, the restart control module 110 may determine the restart controls 112 based at least on the levels of impact that the restarts have on the resource allocations 114, as indicated by the restart impacts 108. For example, in some embodiments, resources allocated to functionalities in certain categories and/or functionalities with certain priorities may not be interfered with at any instance. For example, certain functionalities may be directly associated with the safety of the monitored system 101 such that consistent operations of the functionalities are required. In response to the restart impacts 108 indicating a restart of a functionality possibly affecting resources allocated to such functionalities, the restart control module 110 may pause or stop the restart regardless of the aliveness level.

Modifications, additions, or omissions may be made to FIG. 1 without departing from the scope of the present disclosure. For example, the monitoring system 100 may include more or fewer elements than those illustrated and described in the present disclosure.

FIG. 2 illustrates an example resource allocation system 200 for allocating resources of a system to specific functionalities of a system, in accordance with one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In some embodiments, the resource allocation system 200 may be configured to allocate resources of a monitored system (e.g., the monitored system 101 of FIG. 1) to a set of functionalities 202 associated with the monitored system. In some embodiments, the resource allocation system 200 may generate resource allocations 210 representing the allocated resources. For example, in some embodiments, the resource allocations 210 may include a map representing how different resources are allocated among the functionalities or the subsystems associated with the functionalities. In some embodiments, the resource allocations 210 may correspond to the resource allocations 114 of FIG. 1.

In some embodiments, the resource allocation system 200 may include a categorization module 204 and a resource allocation module 208. In some embodiments, the categorization module 204 may be configured to categorize or assign categories to the individual functionalities of the functionalities 202. For example, the categorization module 204 may generate categorized functionalities 206. The categorized functionalities 206 may include the functionalities 202 with individual functionalities having assigned categories. In some embodiments, the categorization module 204 may categorize the functionalities 202 with respect to a set of categories. In some embodiments, the set of categories may be defined to represent certain characteristics or attributes of the functionalities 202. For instance, individual functionalities 202 assigned to the same category may have shared characteristics or attributes.

In some embodiments, one or more of the modules and/or processes described herein may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as the computing device described in further detail with respect to FIG. 5.

In some embodiments, the set of categories may be defined based at least on the importance of having the functionalities 202 available for safe operations of the system. For example, the functionalities with higher availability requirements may be categorized into a same category compared to other functionality with lower or no availability requirements with respect to safety of the system. In the present disclosure, “availability” may refer to how a functionality may remain available in a functioning condition and ready for use. In some instances, “availability” may be measured by comparing uptime to total time including uptime and downtime. In the present disclosure, reference to “uptime” may refer to the total time an assessed system or components associated therewith are operational and performing intended functions and reference to “downtime” may refer to the total time the system or components are non-operational due to failures, maintenance, or other issues.

In some embodiments, the set of categories with respect to the safety of the system may be defined with respect to certain standards (e.g., local, global, industrial, among others). The standards may require certain levels of operational and/or safety requirements for the system. In these and other embodiments, functionalities 202 may be categorized based at least on how the failures of the functionalities 202 affect the system satisfying the standards. For example, in some embodiments, the set of categories may be determined based on ISO 26262, in which instance the set of categories may include safety-available functionalities, safety-non-available functionalities, and non-safety functionalities. The set of categories including safety-available functionalities, safety-non-available functionalities, and non-safety functionalities is described in further detail with respect to the restart control module 110 of FIG. 1.

In some embodiments, the categorization module 204 may generate the categorized functionalities 206 based on any other suitable standards. While a categorization based on safety standards are discussed. Any other types of categorizations may be used. For example, the categorization may be more granular. For example, the categorization may include an additional number of categories or a smaller number of categories. Additionally or alternatively, in some embodiments, a user may specify custom standards and/or rules of categorizations. For example, the user may specify the particular functionalities to run without being affected. For example, the user may specify the functionalities with reserved memories, regardless of the categorization or how the functionalities may affect the system.

In some embodiments, the resource allocation module 208 may be configured to allocate resources to the categorized functionalities 206 based at least on the categories. In some embodiments, shared resources, such as memory, may be allocated to different functionalities based on the categorization of the functionalities. In some embodiments, certain functionalities may be assigned reserved resources, such as reserved memory. The reserved memories may refer to guaranteed portion of memory allocated for the particular functionalities, such that the guaranteed portion of the memory remains available for the particular functionalities even in instances in which the host system is under memory pressure from other functionalities.

For example, in some embodiments in which the functionalities are implemented on VMs, the hypervisor may allocate the physical memory of the host system (RAM) to the VMs running on the hypervisor based on the categorized functionalities 206. For example, a non-safety related functionality (and the associated VM) may need to restart due to an update or a problem. Even in instances in which the non-safety related functionality requires additional memory resources, memory reserved or dedicated for particular functionalities or VMs corresponding to a different category may not be used for the restart. For example, a first VM running infotainment may be assigned to a first category (e.g., non-safety functionalities) and a second VM running collision avoidance may be assigned to a second category (e.g., safety-available functionalities) that is of higher priority than the first category. In such instance, a restart of the first VM may not be allowed to use the memory or other resources reserved for the second VM.

As another example, specific portions and/or times of different engines may be allocated to the functionalities and/or VMs running on the engines. For example, the engines may be scheduled to perform operations for different functionalities at a certain schedule, such that different functionalities are allocated certain amounts of usages of the engines.

Modifications, additions, or omissions may be made to FIG. 2 without departing from the scope of the present disclosure. For example, the resource allocation system 200 may include more or fewer elements than those illustrated and described in the present disclosure.

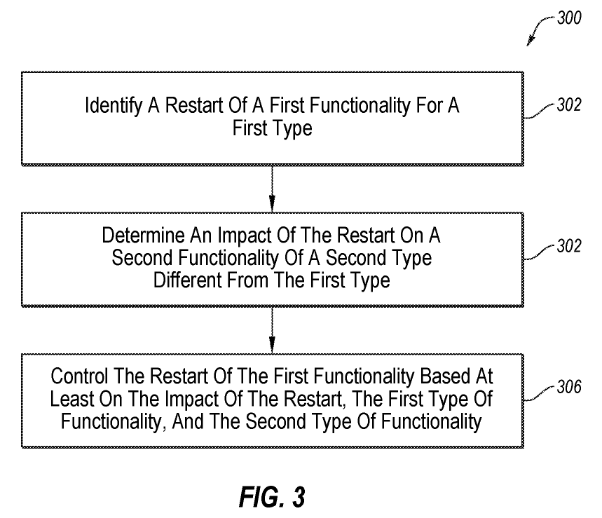

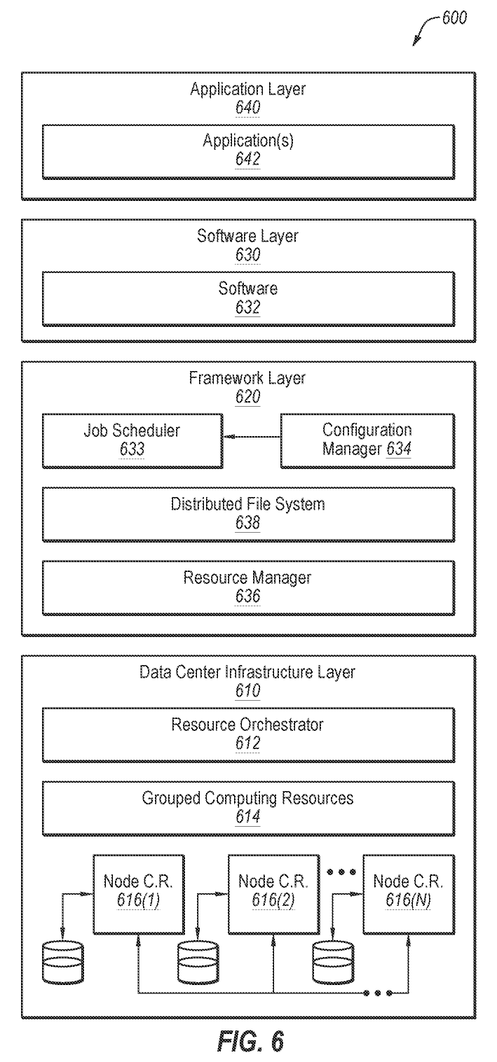

FIG. 3 is a flow diagram illustrating a method 300 of controlling restarts of functionalities, in accordance with one or more embodiments of the present disclosure. One or more operations of the method 300 may be performed by any suitable system, apparatus, or device such as, for example, the monitoring system 100 of FIG. 1, the autonomous vehicle described with respect to FIGS. 4A-4D, computing device(s) described with respect to FIG. 5, and/or the data system(s) described with respect to FIG. 6 in the present disclosure.

At block 302, a restart of a first functionality may be identified. In some embodiments, the first functionality may be a first type of functionality. In some embodiments, the first functionality may be a part of a monitored system, such as the monitored system 101 of FIG. 1. In some embodiments, the monitored system may include any systems or machines that include a set of functionalities and/or subsystems. Some examples of a monitored system include vehicles, autonomous vehicles, semi-autonomous vehicles, watercraft, aircraft, drones, robots (e.g., humanoid, autonomous mobile robot (AMR), forklifts, etc.), automobiles, trucks, buses, bicycles, trains, motorcycles, computing systems, among others. In some embodiments, the functionalities may be implemented using corresponding processors. Additionally or alternatively, the functionalities may be implemented using respective virtual machines (VMs) running on the processors. In some embodiments, the subsystems may include different engines and/or VMs configured to implement the functionalities. For example, the first functionality may be implemented using a first set of engines of the monitored system.

In some embodiments, the first functionality may be designated to restart for various reasons. For example, the first functionality may require a restart for software updates, performance degradation, error recovery, among others. As the first functionality initiates the restarting process, the initiation may be identified.

At block 304, an impact of the restart of the first functionality on a second functionality may be determined—e.g., such as described with respect to determining the restart impacts 108 with respect to FIG. 1. In some embodiments, the second functionality may be a second type of functionality. In some embodiments, the second functionality may another functionality associated with the monitored system. In some embodiments, the second functionality may be implemented using a second set of engines. In some embodiments, the first functionality and the second functionality may be implemented using VMs running on a same host system. For example, the VMs implementing the first functionality and the second functionality, respectively, may be run using the same set of engines or host system.

In these and other embodiments, the first functionality and the second functionality may have shared resources. For example, the first functionality and the second functionality may both use memory (e.g., the RAM) of the monitored system. In some embodiments, the identified restart of the first functionality may have an impact on the second functionality. For example, the restart may affect the use of the shared resources for the second functionality.

In some embodiments, certain functionalities may be prioritized as compared to other functionalities. In some embodiments, the priorities of the functionalities may be determined based at least on categories assigned to the functionalities. In some embodiments, the functionalities may be categorized based on the how the failures of the functionalities may affect the system and to allocate sufficient resources for certain functionalities whose consistent performance is needed.

In some embodiments, the first type of functionality and the second type of functionality may represent categories assigned to the first functionality and the second functionality. In some embodiments, the categories may be assigned from a plurality of categories to individual functionalities of one or more functionalities including at least the first functionality and the second functionality. In some embodiments, the categories may be assigned to the one or more functionalities based on different standards and measurements. For example, in some embodiments, the categories may be assigned based at least on one or more respective safety levels associated with the one or more functionalities.

In some embodiments, the different categories may be associated with different priorities. For example, the functionalities assigned to the second type or category may be prioritized more than the functionalities assigned to the first type or category. For example, with respect to safety levels, the functionalities assigned to categories with higher safety level may be prioritized over the functionalities assigned to categories with lower safety levels.

In some embodiments, the first functionality and the second functionality may be assigned allocation of shared resources between the first functionality and the second functionality based at least on the first type of functionality and the second type of functionality, respectively. For example, different resources such as memory, processing threads, among others, may be assigned to different functionalities. In these and other embodiments, the impact of the restart on the second functionality may include the impact of the restart on the shared resources allocated to the second functionality.

In some embodiments, the impact of the restart of the first functionality on the second functionality may be determined based at least on aliveness of the second functionality. Aliveness may refer to a measure of how often a functionality is invoked or executed. In some embodiments, the aliveness of the functionalities may be described in further detail with respect to the restart impact module 106.

At block 306, the restart of the first functionality may be controlled based at least on the impact of the restart, the first type of functionality, and the second type of functionality. For example, the restart may be allowed, paused, or stopped based at least on the impact of the restart, the first type of functionality, the second type of functionality. For example, in instances in which the second type of functionality has a higher priority than the first type of functionality, and the restart of the first functionality has an impact on the operations of the second functionality, the restart may be paused or stopped.

In some instances, the paused restarts may be allowed to resume at certain instances. For example, the restart may be pushed down the list of priorities given to different tasks. The first functionality may be allowed to resume the restart process after more prioritized tasks are performed. For example, the first functionality may resume the restart after the second functionality comes to an idle or a pause. In some instances, the paused or stopped restarts may be fully abandoned. For example, the restart may move down the priorities list and eventually off the task list. In such instances, the restart may be reinitiated at a later instance or manually by a user. In some embodiments, determination of the controls may be described in further detail with respect to monitoring system 100 and the restart control module 110 of FIG. 1.

In some examples, the systems and methods described herein may allow for the vehicle, robot, or other machine type to satisfy an automotive safety integrity level (ASIL) B or higher, such as ASIL D, due to the deterministic nature of evaluated impact on safety of different functionalities. For example, because safety-critical features, applications, or functionalities may be maintained and prioritized over less or non-safety-critical features, the vehicle, robot, or machine may be capable of satisfying stringent safety levels – such as ASIL D or other safety integrity levels including but not limited to those included in the ISO 26262 standard.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### EXAMPLE AUTONOMOUS VEHICLE

FIG. 4A is an illustration of an example autonomous vehicle 400, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) "Taxonomy and Definitions for Terms Related to Driving Automation Systems for On-Road Motor Vehicles” (Standard No. J3016-201806, published on June 15, 2018, Standard No. J3016-201609, published on September 30, 2016, and previous and future versions of this standard). The vehicle 500 may be capable of functionality in accordance with one or more of Level 3 – Level 5 of the autonomous driving levels. The vehicle 500 may be capable of functionality in accordance with one or more of Level 1 – Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more CPU(s), system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, and/or to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) 546 (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the HD map 522 of FIG. 5C), location data (e.g., the location of the vehicle 500, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524, which may use one or more wireless antenna(s) 526 and/or modem(s) to communicate over one or more networks. For example, the network interface 524 may be capable of communication over LTE, WCDMA, UMTS, GSM, CDMA2000, etc. The wireless antenna(s) 526 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera’s image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward-facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may any number of wide-view cameras 570 on the vehicle 500. In addition, long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

One or more stereo cameras 568 may also be included in a front-facing configuration. The stereo camera(s) 568 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle’s environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360-degree camera(s), and/or the like. For example, four fisheye cameras may be positioned on the vehicle’s front, rear, and sides. In an alternative arrangement, the vehicle may use three surround camera(s) 574 (e.g., left, right, and rear), and may leverage one or more other camera(s) (e.g., a forward-facing camera) as a fourth surround-view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C is illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA’s CUDA).

The GPU(s) 508 may be power-optimized for best performance in automotive and embedded use cases. For example, the GPU(s) 508 may be fabricated on a Fin field-effect transistor (FinFET). However, this is not intended to be limiting, and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected to both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500 – such as processing DNNs. In addition, the SoC(s) 504 may include a floating point unit(s) (FPU(s)) – or other math coprocessor or numeric coprocessor types – for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. Patent Application No. 16/101,232, filed on August 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA’s capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe-stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle’s destination, activate or change the vehicle’s infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle’s path-planning software (preferably executing on the CPU Complex) that when flashing lights are detected, icy conditions exist. The flashing light may be identified by operating a third deployed neural network over multiple frames, informing the vehicle’s path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always-on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA’s NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528, which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPD (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data, in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle’s 500 surrounding at higher speeds with minimal interference from traffic in adjacent lanes. The other two antennae may expand the field of view, making it possible to quickly detect vehicles entering or leaving the vehicle’s 500 lane.

Mid-range RADAR systems may include, as an example, a range of up to 160m (front) or 80m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5m, 4m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 100m, with an accuracy of 2cm-3cm, and with support for a 100Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane. BSW systems detects and warn the driver of vehicles in an automobile’s blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer’s confidence in the chosen result. If the confidence score exceeds a threshold, the supervisory MCU may follow the primary computer’s direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer’s output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer’s perception block and/or the primary computer’s dynamic driving task block. For example, if the ADAS system 538 indicates a forward crash warning due to an object immediately ahead, the perception block may use this information when identifying objects. In other examples, the secondary computer may have its own neural network that is trained and thus reduces the risk of false positives, as described herein.

The vehicle 500 may further include the infotainment SoC 530 (e.g., an in-vehicle infotainment system (IVI)). Although illustrated and described as an SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands-free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe-stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA’s TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, include wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

### EXAMPLE DATA CENTER

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)- 716(N), where “N” represents any whole, positive integer. In at least one embodiment, node C.R.s 716(1)- 716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)- 716(N) may correspond to a server having one or more of the above-mentioned computing resources. In addition, in some embodiments, the node C.R.s 716(1)- 716(N) may include one or more virtual components, such as vGPUs, vCPUs, and/or the like, and/or one or more of the node C.R.s 716(1)- 716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)- 716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 732, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache SparkTM (hereinafter “Spark”) that may utilize distributed file system 738 for large-scale data processing (e.g., "big data"). In at least one embodiment, job scheduler 732 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)- 716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)- 716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 700. In at least one embodiment, trained or deployed machine learning models corresponding to one or more neural networks may be used to infer or predict information using resources described in the present disclosure with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6 – e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

### Example 1. A method comprising:

identifying a restart of a first functionality for a first type;

determining an impact of the restart on a second functionality of a second type different from the first type; and

controlling the restart of the first functionality based at least on the impact of the restart, the first type of functionality, and the second type of functionality.

The method of Example 1, wherein the first type of functionality and the second type of functionality represent priorities assigned to the first functionality and the second functionality, respectively.

The method of Example 1, wherein the first type of functionality and the second type of functionality represent categories of the first functionality and the second functionality, assigned from a plurality of categories to individual functionalities of one or more functionalities, comprising the first functionality and the second functionality of a system, the priorities being determined based at least on the categories.

The method of Example 1, wherein the categories are assigned to the one or more functionalities based at least on one or more respective safety levels associated with the one or more functionalities.

The method of Example 1, wherein the first functionality and the second functionality are assigned allocation of shared resources between the first functionality and the second functionality based at least on the first type of functionality and the second type of functionality, respectively.

The method of Example 1, wherein the impact of the restart on the second functionality is determined based at least on interference caused by the restart on the shared resources allocated to the second functionality and the first functionality.

The method of Example 1, wherein the first functionality and the second functionality are implemented using virtual machines running on a same host system.

The method of Example 1, wherein the first functionality is implemented using a first set of engines and the second functionality is implemented using a second set of engines, the first set of engines and the second set of engines having shared resources.

The method of Example 1, wherein the impact of the restart on the second functionality is determined based at least on aliveness of the second functionality.

### Example 2. A system comprising:

one or more processors to cause performance of operations comprising:

identifying a restart of a first functionality of a first type;

determining an impact of the restart on a second functionality of a second type different from the first type; and

controlling the restart of the first functionality based at least on the impact of the restart, the first type of functionality, and the second type of functionality.

The system of Example 2, wherein the first type of functionality and the second type of functionality represent priorities assigned to the first functionality and the second functionality, respectively.

The system of Example 2, wherein the first type of functionality and the second type of functionality represent categories of the first functionality and the second functionality, assigned from a plurality of categories to individual functionalities of one or more functionalities, comprising the first functionality and the second functionality of a system, the priorities being determined based at least on the categories.

The system of Example 2, wherein the categories are assigned to the one or more functionalities based at least on one or more respective safety levels associated with the one or more functionalities.

The system of Example 2, wherein the first functionality and the second functionality are assigned allocation of shared resources between the first functionality and the second functionality based at least on the first type of functionality and the second type of functionality, respectively.

The system of Example 2, wherein the impact of the restart on the second functionality is determined based at least on interference caused by the restart on the shared resources allocated to the second functionality and the first functionality.

The system of Example 2, wherein the first functionality and the second functionality are implemented using virtual machines running on a same host system.

The system of Example 2, wherein the first functionality is implemented using a first set of engines and the second functionality is implemented using a second set of engines, the first set of engines and the second set of engines having shared resources.

The system of Example 2, wherein the system is comprised in at least one of:

a control system for an autonomous or semi-autonomous machine;

a perception system for an autonomous or semi-autonomous machine;

a system for performing simulation operations;

a system for performing digital twin operations;

a system for performing light transport simulation;

a system for performing collaborative content creation for 3D assets;

a system for performing deep learning operations;

a system for presenting at least one of augmented reality content, virtual reality content, or mixed reality content;

a system for hosting one or more real-time streaming applications;

a system implemented using an edge device;

a system implemented using a robot;

a system for performing conversational AI operations;

a system for performing one or more generative AI operations;

a system implementing one or more large language models (LLMs);

a system implementing one or more vision language models (VLMs);

a system implementing one or more multi-modal language models;

a system for generating synthetic data;

a system incorporating one or more virtual machines (VMs);

a system implemented at least partially in a data center; or

a system implemented at least partially using cloud computing resources.

### Example 3. One or more processors comprising:

processing circuitry to cause performance of operations comprising:

identifying a restart of a first functionality of a first type;

determining an impact of the restart on a second functionality of a second type different from the first type; and

controlling the restart of the first functionality based at least on the impact of the restart, the first type of functionality, and the second type of functionality,

wherein, based at least on controlling of the restart of the first functionality, a machine including the one or more processors is capable of satisfying automotive safety integrity level (ASIL) D.

What is claimed is:

1. A method comprising:
identifying a restart of a first functionality for a first type;
determining an impact of the restart on a second functionality of a second type different from the first type; and
controlling the restart of the first functionality based at least on the impact of the restart, the first type of functionality, and the second type of functionality.

2. The method of claim 1, wherein the first type of functionality and the second type of functionality represent priorities assigned to the first functionality and the second functionality, respectively.

3. The method of claim 2, wherein the first type of functionality and the second type of functionality represent categories of the first functionality and the second functionality, assigned from a plurality of categories to individual functionalities of one or more functionalities, comprising the first functionality and the second functionality of a system, the priorities being determined based at least on the categories.

4. The method of claim 3, wherein the categories are assigned to the one or more functionalities based at least on one or more respective safety levels associated with the one or more functionalities.

5. The method of claim 1, wherein the first functionality and the second functionality are assigned allocation of shared resources between the first functionality and the second functionality based at least on the first type of functionality and the second type of functionality, respectively.

6. The method of claim 5, wherein the impact of the restart on the second functionality is determined based at least on interference caused by the restart on the shared resources allocated to the second functionality and the first functionality.

7. The method of claim 1, wherein the first functionality and the second functionality are implemented using virtual machines running on a same host system.

8. The method of claim 1, wherein the first functionality is implemented using a first set of engines and the second functionality is implemented using a second set of engines, the first set of engines and the second set of engines having shared resources.

9. The method of claim 1, wherein the impact of the restart on the second functionality is determined based at least on aliveness of the second functionality.

10. A system comprising:
one or more processors to cause performance of operations comprising:
identifying a restart of a first functionality of a first type;
determining an impact of the restart on a second functionality of a second type different from the first type; and
controlling the restart of the first functionality based at least on the impact of the restart, the first type of functionality, and the second type of functionality.

11. The system of claim 10, wherein the first type of functionality and the second type of functionality represent priorities assigned to the first functionality and the second functionality, respectively.

12. The system of claim 11, wherein the first type of functionality and the second type of functionality represent categories of the first functionality and the second functionality, assigned from a plurality of categories to individual functionalities of one or more functionalities, comprising the first functionality and the second functionality of a system, the priorities being determined based at least on the categories.

13. The system of claim 12, wherein the categories are assigned to the one or more functionalities based at least on one or more respective safety levels associated with the one or more functionalities.

14. The system of claim 10, wherein the first functionality and the second functionality are assigned allocation of shared resources between the first functionality and the second functionality based at least on the first type of functionality and the second type of functionality, respectively.

15. The system of claim 14, wherein the impact of the restart on the second functionality is determined based at least on interference caused by the restart on the shared resources allocated to the second functionality and the first functionality.

16. The system of claim 10, wherein the first functionality and the second functionality are implemented using virtual machines running on a same host system.

17. The system of claim 10, wherein the first functionality is implemented using a first set of engines and the second functionality is implemented using a second set of engines, the first set of engines and the second set of engines having shared resources.

18. The system of claim 10, wherein the impact of the restart on the second functionality is determined based on aliveness of the second functionality.

19. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

20. One or more processors comprising:
processing circuitry to cause performance of operations comprising:
identifying a restart of a first functionality of a first type;
determining an impact of the restart on a second functionality of a second type different from the first type; and
controlling the restart of the first functionality based at least on the impact of the restart, the first type of functionality, and the second type of functionality,
wherein, based at least on controlling of the restart of the first functionality, a machine including the one or more processors is capable of satisfying automotive safety integrity level (ASIL) D.
